(19) United States
(12) Patent Application Publication
(10) Pub. No.: US 2012/0063485 A1
(43) Pub. Date: Mar. 15, 2012

(54) THERMAL ENDURANCE TESTING APPARATUS AND METHODS FOR PHOTOVOLTAIC MODULES

(75) Inventor: Max William Reed, Niwot, CO (US)

(73) Assignee: PRIMESTAR SOLAR, INC., Arvada, CO (US)

(21) Appl. No.: 13/073,410

(22) Filed: Mar. 28, 2011

(51) Int. Cl. G01N 25/72

(52) U.S. Cl. 374/5

(57) ABSTRACT

Apparatus and methods for testing the thermal endurance of a glass substrate of a photovoltaic module are provided. The apparatus generally includes, in one embodiment, a testing chamber defining an interior space having an interior atmosphere. A refrigeration unit is operably positioned with the testing chamber to control the interior atmosphere's temperature. A mounting system is positioned within the interior space of the testing chamber and configured to hold the photovoltaic module while exposing the glass substrate of the photovoltaic module. An edge cooling system is positioned in relation to the mounting system such that the photovoltaic module held by the mounting system has a first side edge in contact with the edge cooling system. A light system is also positioned within the interior space of the testing chamber to illuminate the glass substrate of the photovoltaic module.

### FIELD OF THE INVENTION

The subject matter disclosed herein relates generally to the testing photovoltaic modules. More particularly, the subject matter is related to methods and apparatus for testing the thermal endurance of photovoltaic (PV) modules.

### BACKGROUND OF THE INVENTION

Glass flaws under tensile stress can become initiation points for crack propagation. The momentary strength of glass is dependent on the severity of its flaws, its stress history, and the amount of surface compression (heat strengthening) present in the glass. Methods for inducing fast fracture are deemed “highly accelerated life tests” that can provide a fractured surface to be analyzed with fractography techniques so that the tensile stress present at the moment of failure can be measured. This technique provides a measure of the severity of flaws in the glass; however, it does not provide the actual stress magnitude which was applied to the sample at the moment of failure. And, since such highly accelerated life tests have no knowledge of compressive stress which could be present in the sample, these tests cannot directly determine a glass's ability to resist thermal fatigue.

Above the stress corrosion limit, the velocity \ at which a crack will grow is related to the stress intensity at the crack tip. Also, when water is present in combination with a crack opening stress at the crack tip, a phenomenon known as stress corrosion occurs, whereby the water chemically attacks the molecular bonds at the crack tip. Crack velocity is dramatically increased under the influence of stress corrosion. Therefore, it is important to understand the behavior of glass when it is under both thermal stress and in the presence of water.

For photovoltaic modules (i.e., solar panels) placed outdoors, its glass face (i.e., a glass substrate) is exposed to an abundance of sunlight and a constantly changing environment introduced by changes in the weather. For example, in certain areas, the module may be exposed to moisture in the form of rain and/or snow. Under conditions which will cause the snow to melt, snow can slide down the face of the glass, and collect in the gaps between the solar modules in an array. The face of the solar module may then be exposed to direct sunlight, while the horizontal edges remain covered with snow. As such, the edge of the module may remain at a different temperature than the face of the module, creating a temperature gradient in the module.

This temperature gradient in the module, along with the constant changes in the environment, can cause thermal stress and/or fatigue to develop in the glass, which can weaken the glass and shorten the lifespan of the module. However, methods for evaluating the strength of the glass do not account for the thermal stresses which can be applied over the lifetime of a solar panel. For example, in the scenario of a module with sufficient heat strengthening and low flaw severity, the applied thermal stresses may not be high enough to produce a stress intensity greater than the stress corrosion limit. As such, no crack growth would be realized after repeated heat/cool cycles. Conversely, for the scenario of a module with insufficient heat strengthening and a sufficiently high flaw severity, the applied thermal stresses may produce a stress intensity greater than the stress corrosion limit, resulting in slow crack growth or thermal fatigue at the flaws over repeated heat/cool cycles.

Therefore, in order to ensure that a module can withstand a lifetime of applied thermal stress, a need exists for a method and apparatus for accurately predicting a module's ability to resist thermal stress and/or fatigue over a period of time.

### BRIEF DESCRIPTION OF THE INVENTION

Aspects and advantages of the invention will be set forth in part in the following description, or may be obvious from the description, or may be learned through practice of the invention.

An apparatus is generally disclosed for testing the thermal endurance of a glass substrate of a photovoltaic module. The apparatus generally includes, in one embodiment, a testing chamber defining an interior space having an interior atmosphere. A refrigeration unit is operably positioned with the testing chamber to control the interior atmosphere's temperature. A mounting system is positioned within the interior space of the testing chamber and configured to hold the photovoltaic module while exposing the glass substrate of the photovoltaic module. An edge cooling system is positioned in relation to the mounting system such that the photovoltaic module held by the mounting system has a first side edge in contact with the edge cooling system. A light system is also positioned within the interior space of the testing chamber to illuminate the glass substrate of the photovoltaic module.

A method is also generally provided for testing the thermal endurance of a glass substrate of a photovoltaic module. First, the photovoltaic module is placed within a testing chamber that defines an interior space having an interior atmosphere. The interior atmosphere's temperature can then be reduced within the testing chamber to an initial temperature of about −25° C. to about 0° C. An edge of the photovoltaic module can be submerged in water, and the glass substrate of the photovoltaic module can be illuminated using a lighting system.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 shows a perspective view of an exemplary testing chamber according to one embodiment;

FIG. 2 shows a cross-sectional view of the exemplary testing chamber of FIG. 1;

FIG. 3 shows a cross-sectional view of the exemplary edge cooling system for use in conjunction with the exemplary testing chamber of FIG. 1;

FIG. 4 shows multiple photovoltaic modules loaded on an exemplary mounting system according to one embodiment; and,

FIG. 5 shows a front view of an exemplary light system, as positioned within the exemplary testing chamber of FIG. 1.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Apparatus and methods are provided for testing the thermal endurance of a glass substrate of a PV module (i.e., solar panel) and/or measuring its resistance to thermal fatigue under a variety of environmental conditions. The apparatus and methods can simulate cycles of known thermal stresses to the module along the long side edge with water present, allowing the glass to experience stress corrosion if the stress and/or flaws are severe enough. As such, the apparatus and methods can develop a stress history in the module by applying thermal stress in cycles, which can be designed to mimic environmental conditions in the field.

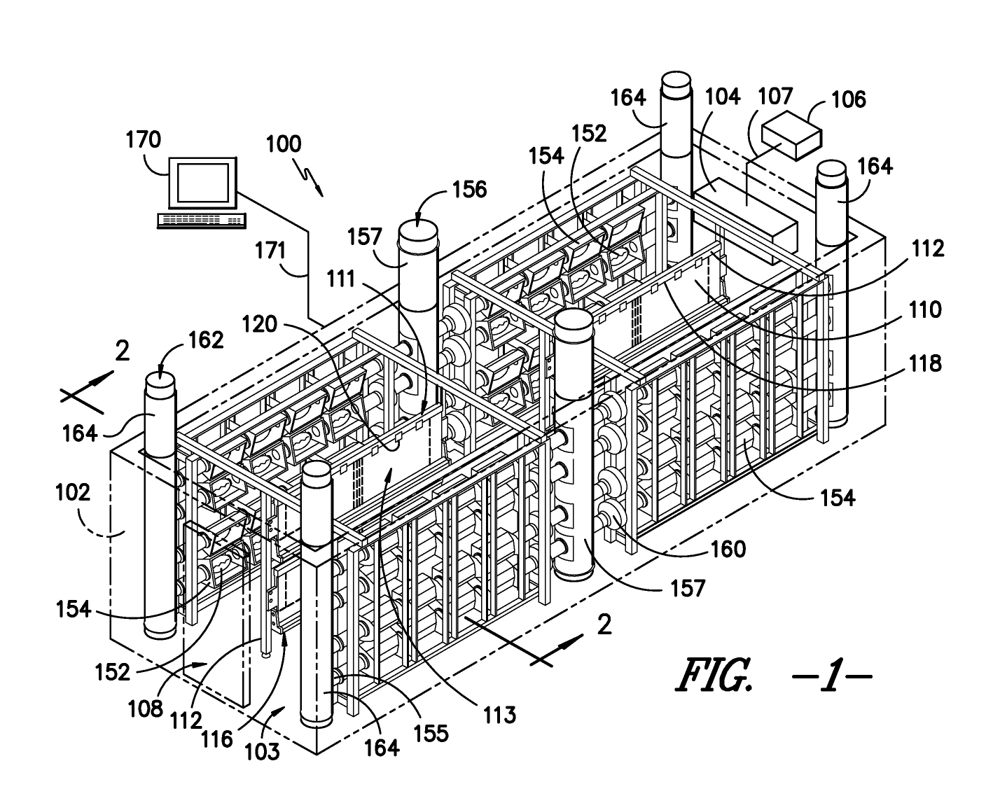

One particular embodiment of an apparatus 100 suitable for testing the thermal endurance of a glass substrate of a PV module is shown in FIG. 1. The apparatus 100 includes a testing chamber 102 defining an interior space 103 having an interior atmosphere. The testing chamber 102 can be described in the shown embodiment as an insulated freezer that is configured to be atmospherically isolated from the outside environment. The temperature within the testing chamber 102 can be controlled via a thermostat 104 connected to a refrigeration unit 106 that is operably positioned with the testing chamber to control the interior atmosphere's temperature. As such, the refrigeration unit 106 is configured to control the air temperature of the interior atmosphere within the testing chamber 102, for example capable of reducing the air temperature to about −25° C. from room temperature (e.g., about 25° C.), while being controllable via the thermostat 104 as desired. The thermostat 104 is shown connected to the refrigeration unit 106 via communication link 107 (e.g., a wired or wireless communication link). For example, the refrigeration unit 106 can be a commercial grade refrigeration unit top mounted compressor with evaporator coils extending into the interior of the testing chamber 102.

The testing chamber 102 is shown having a door 108 providing walk-in access for a tester into the testing chamber 102 to allow the tester to change the PV modules 110 being tested. Upon closing, the door 108 can insulate the interior of the testing chamber 102 from the outside environment.

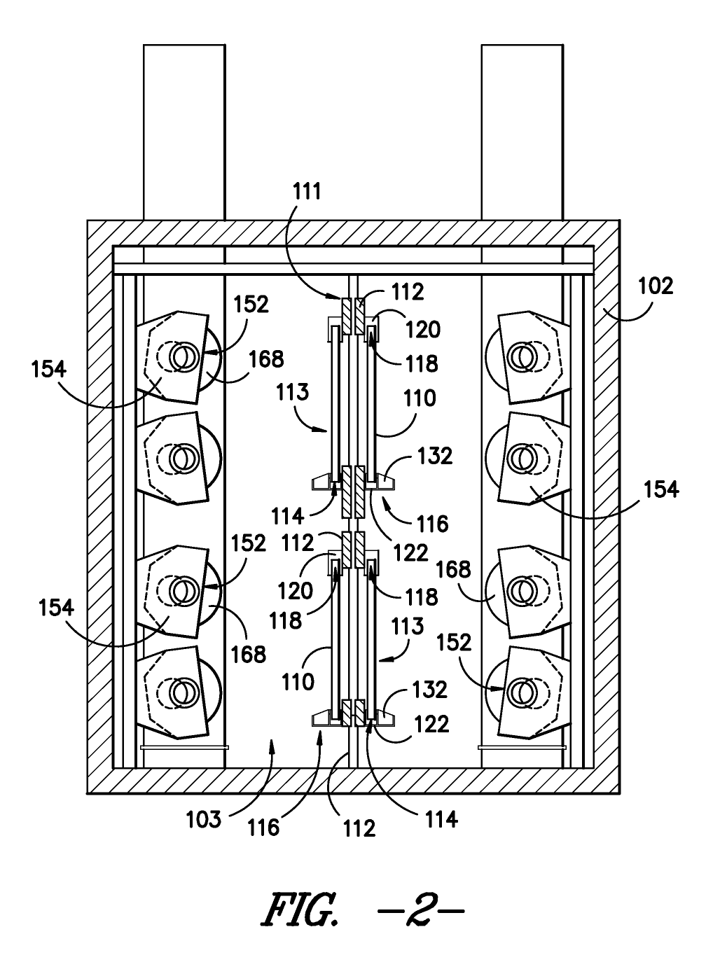

As more particularly shown in FIG. 2, the PV modules 110 are shown loaded in a mounting system 111 that includes a frame assembly 112. The mounting system 111 is positioned within the interior space 103 of the testing chamber 102 and configured to hold the PV modules 110 while exposing their glass substrate or glass face 113. As shown, the PV modules 110 are held in back to back configuration so that their face 113 is directly exposed to the light bank. In particular, the mounting system 111 is configured to hold the PV module 110 such that its first longitudinal side edge 114 is in contact with an edge cooling system 116. In the shown embodiment, the mounting system 111 removably secures the PV module 110 along a second longitudinal side edge 118 via mounting clips 120 to the frame assembly 112. Additionally, in some embodiments, the modules 110 may be secured to the mounting system 111 along its bottom, first longitudinal side edge 114 via additional clips (not shown) that become submerged in the water during operation. As such, the PV modules 110 are suspended vertically from the second longitudinal side edge 118 such that the first longitudinal side edge 116 is oriented substantially underneath the second longitudinal side edge 118 and the glass 113 is facing outwardly from the frame assembly 112. However, any suitable mounting system can be utilized to removably hold the PV modules 110 in the testing chamber 102, as long as the glass face 113 is substantially unblocked to receive light during testing and at least one side edge is in contact with the edge cooling system 116.

Additionally, the PV modules 110 can be electrically connected to function as if set in actual operation.

The edge cooling system 116 is positioned in relation to the mounting system 111 such that the PV module 110 has its first longitudinal side edge 114 in contact with the edge cooling system 116. Due to this configuration, the temperature of the first longitudinal side edge 114 can be separately controlled compared to the temperature of the interior atmosphere of the testing chamber 102. For example, in one embodiment, the temperature of the first longitudinal side edge 114 can be kept at a relatively constant temperature (e.g., at an edge temperature of about 0° C. to about 5° C., such as greater than about 0° C. to about 2° C.), while the temperature of the interior atmosphere is varied through testing cycles as explained in greater detail below.

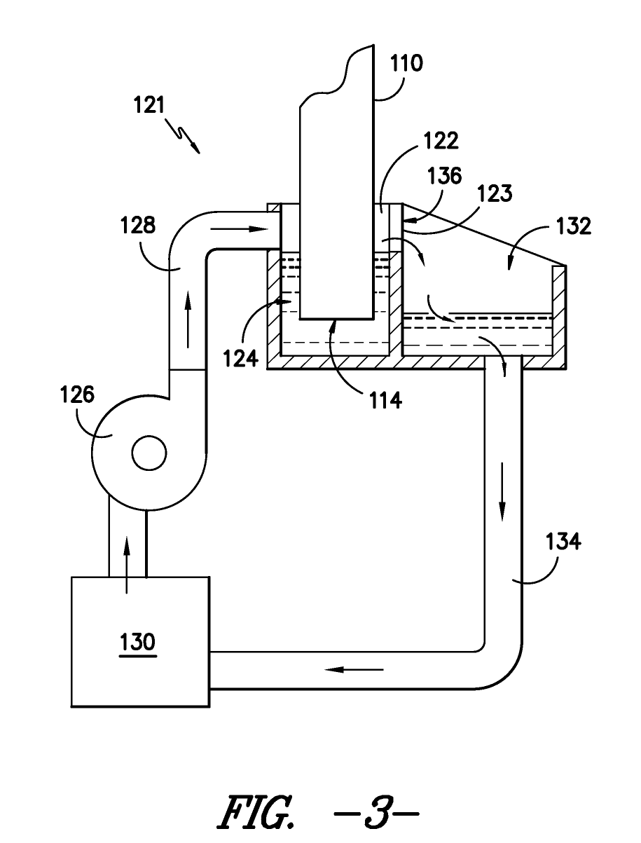

In the embodiments shown in FIGS. 1-4, for example, the edge cooling system 116 includes a water trough 122 positioned such that the first longitudinal side edge 114 of the photovoltaic module 110 is submerged in water 124. Referring to FIG. 3, a water circulation system 121, for use as an exemplary edge cooling system 116, is shown having a water pump 126 operably connected to the water trough 122 and configured to circulate water 124 through the water trough 122 via a supply pipe 128. A water cooling device 130 is also shown to keep the circulating water 124 at the desired water temperature. Such water cooling devices 130 are known in the art and generally act as a refrigerator unit to cool the temperature of the water 124 being circulated therethrough.

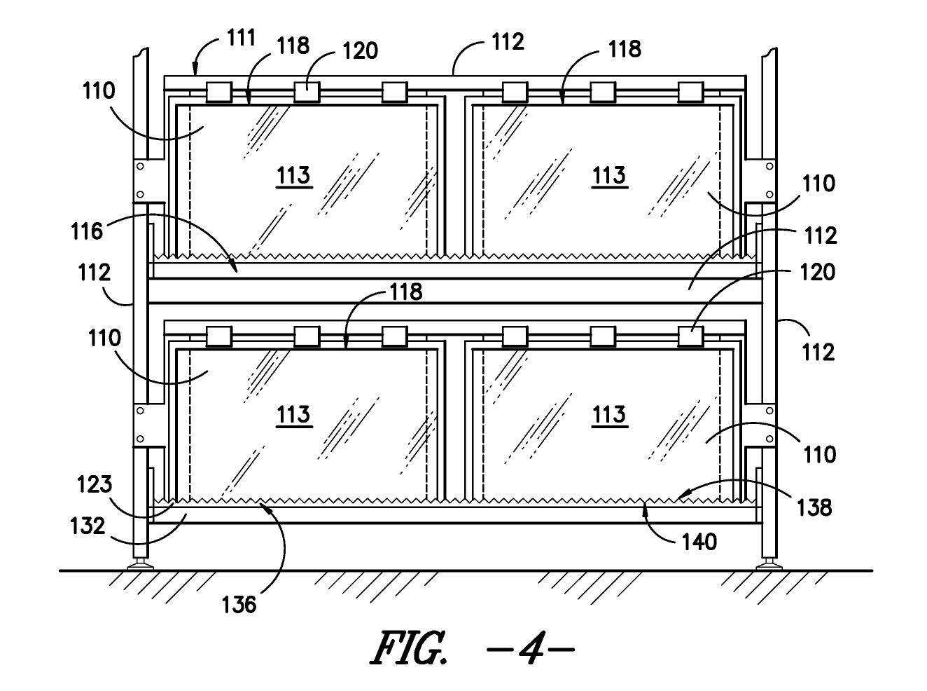

The water trough 122 is configured to receive water 124 from the water pump 126 via the supply pipe 128 while keeping the first longitudinal side edge 114 of the photovoltaic module 110 submerged. Excess water 124 flows out of the water trough 122 over the trough's front wall 123 into a collection reservoir 132. As shown in FIG. 4, the trough's front wall 123 has a jagged edge 136 that defines peaks 138 and valleys 140. As the water level in the water trough 122 rises, water 124 will drain flow over the trough's front wall 123, first through the valleys 140. This configuration ensures that the water level is substantially uniform over the entire length of the water trough 122, no matter the positioning of the supply pipe 128.

The collection reservoir 132 is attached to a drainage pipe 134 allowing the excess water flowing from the water trough 122 to drain to the water cooling device 130 and/or water pump 126 in order to circulate within the water circulation system 121. The flow of water 124 through the water circulation system 121 can be adjusted to maintain the temperature of the first longitudinal side edge 114 of the photovoltaic module 110 at the desired edge temperature.

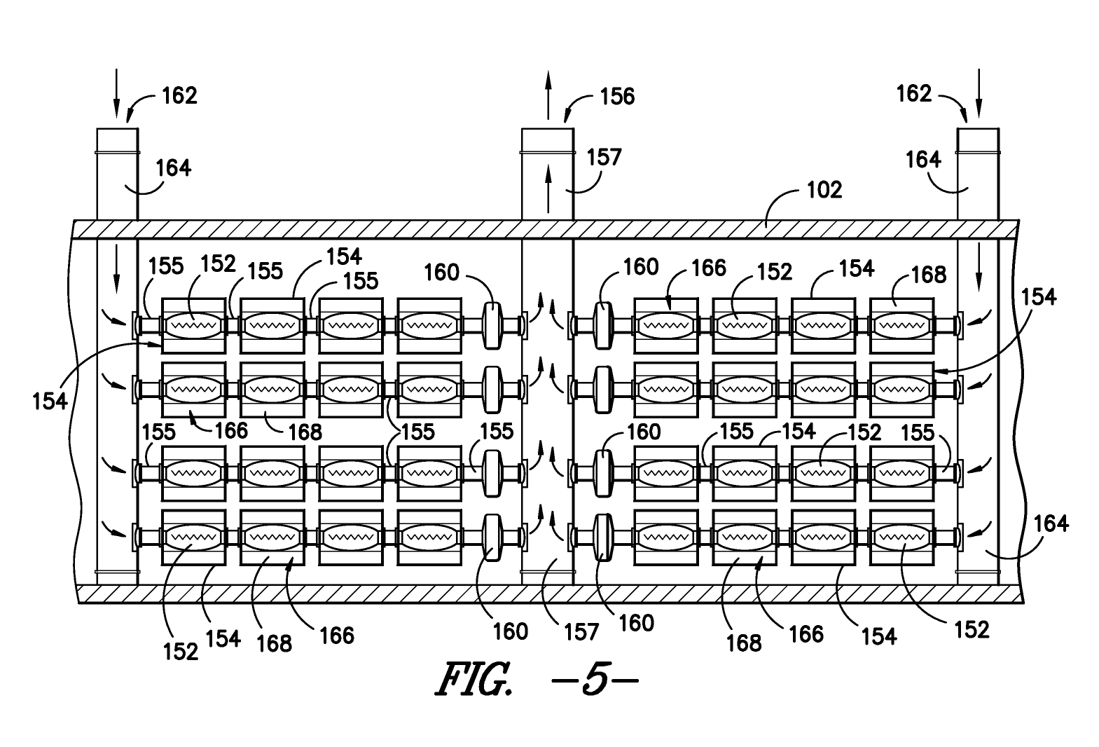

A light system 150 is also positioned within the interior space 103 of the testing chamber 102 to illuminate the glass face 113 of the photovoltaic module 110. As shown in FIG. 5, the light system 150 includes a light source 152 positioned within a light housing 154. The light housing 154 defines a housing atmosphere that is substantially isolated from the interior atmosphere of the testing chamber 102.

In the embodiment shown, a ventilation port 156 is in fluid communication with the light housing 154 and is configured to vent the housing atmosphere to the outside air. As used herein, the term “fluid communication” means that a fluid, in this case a gas (i.e., air), can flow therebetween either directly or indirectly. As shown, adjacent light housings 154 are connected to each other via pipes 155 to form rows 158. Each row 158 is in fluid communication with the ventilation port 156. Multiple rows 158 of light sources 152 and light housings 154 can be utilized, each in fluid communication with the ventilation port 156 allowing the entire light system to be vented to the outside atmosphere. However, other configurations can be utilized, such as multiple ventilation ports, etc.

In the embodiment shown, a ventilation fan 160 is positioned between the light housings and the ventilation pipe 157 to pull gas from the housing atmosphere to the ventilation pipe 157. Additionally, an intake port 162 can supply air from outside of the testing chamber 102 to the light housings 154 via the intake pipe 164. As such, the ventilation fan 160 can circulate air from the intake port 162, through the light housings 154, and out of the ventilation port 156. As such, convective heating of the air surrounding the light sources 152 is exhausted from the light housings 154 without having mixed with the cold air in the interior space 113 of the testing chamber 102.

The light sources 152 can be any suitable light source. In one particular embodiment, the light source 152 can simulate the light spectrum of the sun (e.g., radiation with a wavelength between about 350 nm and about 800 nm, such as about 360 nm to about 760 nm). For example, suitable light sources 152 can include xenon arc lamps, metal halide lamps, etc. The light housing 154 can be reflector housing having a reflective back surface 166 and a front window 168. Each of the light sources 152 can be positioned to achieve substantially uniform illumination of the PV modules 110.

As shown, the frame assembly 112 is configured to hold multiple PV modules 110, not only in rows and stacked arrangement, but also in back to back relationship such that two light systems (one on either side of the testing chamber 102) are positioned within the testing chamber 102.

A computing device 170 is connected to the apparatus 100 via communication link 171 (e.g., a wired or wireless communication link) and is configured to control and adjust the temperature of the interior atmosphere of the testing chamber 102 (such as via the thermostat 104), and/or control the light/dark cycles of the light system 150 (i.e., turn the light sources 152 on and off), and/or control the water flow rate and temperature of the edge cooling system 116. For example, the computing device 170 can contain computer program instructions stored in a computer readable medium that can direct the computing device, other programmable data processing apparatus, or other devices to perform the desired functions in a particular manner.

The apparatus 100 can be utilized to perform a method of testing the thermal endurance of the glass face 113 of the photovoltaic module 110. These methods can replicate a typical lifetime of exposure to the outside environment in a relatively short and controlled simulation. According to one embodiment, the photovoltaic module 110 can be placed within the testing chamber 102 and the interior atmosphere's temperature can be reduced to an initial temperature. The initial temperature of the interior atmosphere can be about −25° C. to about 0° C., such as about −25° C. to about −10° C.

The first longitudinal side edge 114 of the photovoltaic module 110 can be submerged in water 124 having a water temperature of about 0° C. to about 10° C. (e.g., greater than about 0° C. to about 5° C.). As stated, water can be circulated through the water circulation system 121, as described above, in order to keep the water temperature substantially stable during each testing cycle.

The testing cycle begins by illuminating the glass face 113 of the photovoltaic module 110 using the lighting system 150. Upon turning the light sources 152 on and illuminating the glass face 113, the interior atmosphere's temperature of the testing chamber 102 will rise due to radiation energy emitted from the lighting system 150. As stated, the rate of the temperature rise can be somewhat controlled via a ventilation system used in conjunction with the light system 150. The interior atmosphere's temperature is allowed to rise to a target temperature, such as about −10° C. to about 25° C. (e.g., about 0° C. to about 10° C.). Once the target temperature is reached, the light system can be turned off (i.e., going dark), and the interior atmosphere's temperature can be reduced back to the initial temperature to complete a testing cycle.

The length of the lighted portion (i.e., light sources turned on) and the dark portion (i.e., light sources turned off) of the testing cycles can be adjusted as desired. In one embodiment, the lighted portion (i.e., light sources turned on) of the testing cycle can last long enough to raise the temperature of the internal atmosphere about 5° C. to about 15° C. (e.g., about 15 minutes to about 2 hours).

This testing cycle can be repeated any number of times to replicate the environmental changes over an extended period. Once the desired number of testing cycles has been completed, the tester can remove the PV modules 110 from the testing chamber 102 for further study.

In particular, these testing cycles are particularly advantageous to replicate an environment where snow or other precipitation has accumulated on the glass face of the photovoltaic module overnight and then has melted and/or evaporated during the day. However, it is found that upon evaporation or melting, the glass face may become substantially dry, but at least one edge can remain wet due to the positioning of the photovoltaic module, which is usually at an angle with one of the longitudinal side edges in a position to receive runoff from the glass face.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An apparatus for testing the thermal endurance of a glass substrate of a photovoltaic module, comprising:
a testing chamber defining an interior space having an interior atmosphere;
a refrigeration unit operably positioned with the testing chamber to control the interior atmosphere's temperature;
a mounting system positioned within the interior space of the testing chamber and configured to hold the photovoltaic module while exposing the glass substrate of the photovoltaic module;
an edge cooling system positioned in relation to the mounting system such that the photovoltaic module held by the mounting system has a first side edge in contact with the edge cooling system; and,
a light system positioned within the interior space of the testing chamber to illuminate at least a portion of the glass substrate of the photovoltaic module.

2. The apparatus as in claim 1, wherein the edge cooling system comprises a water trough positioned such that the side edge of the photovoltaic module is submerged in water.

3. The apparatus as in claim 2, further comprising:
a water circulation system comprising a water pump operably connected to the water trough and configured to circulate water through the water trough.

4. The apparatus as in claim 1, wherein the light system comprises a light source contained within a light housing, and wherein the light housing defines a housing atmosphere that is substantially isolated from the interior atmosphere of the testing chamber.

5. The apparatus as in claim 4, further comprising:
a ventilation port in fluid communication with the light housing and configured to vent the housing atmosphere outside the testing chamber.

6. The apparatus as in claim 5, further comprising:
an intake port in fluid communication with the light housing; and,
a ventilation fan in fluid communication with the light housing and configured to circulate air from the intake port, through the light housing, and out the ventilation port.

7. The apparatus as in claim 6, wherein the light system comprises a bank of light sources, each light source being housed within a light housing an operably connected to the ventilation fan.

8. The apparatus as in claim 1, wherein the mounting system comprises a frame assembly and a clip, wherein the clip removably secures the photovoltaic module to the frame assembly along a second side edge that is opposite of the first side edge.

9. The apparatus as in claim 1, further comprising:
a computing device configured to adjust the temperature of the interior atmosphere of the testing chamber and to control light/dark cycles of the light system.

10. A method for testing the thermal endurance of a glass substrate of a photovoltaic module, the method comprising:
placing the photovoltaic module within a testing chamber, wherein the testing chamber defines an interior space having an interior atmosphere;
reducing the interior atmosphere's temperature within the testing chamber to an initial temperature having a range of about −25° C. to about 0° C.;
submerging an edge of the photovoltaic module in water; and,
illuminating the glass substrate of the photovoltaic module using a lighting system.

11. The method as in claim 10, wherein upon illuminating the glass substrate of the photovoltaic module, the interior atmosphere's temperature rises to a target temperature from the initial temperature.

12. The method as in claim 11, wherein the target temperature is about 0° C. to about 25° C.

13. The method as in claim 11, further comprising:
upon reaching the target temperature, turning the lighting system off.

14. The method as in claim 13, further comprising:
upon turning the lighting system off, reducing the interior atmosphere's temperature back to the initial temperature to complete a testing cycle.

15. The method as in claim 14, further comprising:
repeating testing cycle a desired number of times to test the photovoltaic module.

16. The method as in claim 10, wherein the water has a water temperature of about 0° C. to about 10° C.

17. The method as in claim 16, further comprising:
circulating water through a trough and pump system to the water temperature substantially stable.

18. The method as in claim 10, wherein the light system comprises a light source contained within a light housing, and wherein the light housing defines a housing atmosphere that is substantially isolated from the interior atmosphere of the testing chamber.

19. The method as in claim 18, further comprising:
venting the housing atmosphere outside the testing chamber.

20. The method as in claim 19, wherein the light system further comprises a ventilation port, an intake port, and a ventilation fan in fluid communication with the light housing and configured to circulate air from the intake port, through the light housing, and out the ventilation port.
